(19) United States
(12) Patent Application Publication
(10) Pub. No.: US 2009/0164196 A1
(43) Pub. Date: Jun. 25, 2009

(54) METHOD AND APPARATUS OF CIRCUIT SIMULATION OF HIGH-WITHSTAND-VOLTAGE MOS TRANSISTOR

(75) Inventor: Fumitoshi SAITOU, Kawasaki-shi (JP)

Correspondence Address: YOUNG & THOMPSON, 209 Madison Street, Suite 500, ALEXANDRIA, VA, 22314, US

(73) Assignee: NEC ELECTRONICS CORPORATION, KANAGAWA (JP)

(21) Appl. No.: 12/336,012

(22) Filed: Dec. 16, 2008

(30) Foreign Application Priority Data
Dec. 20, 2007 (JP) 2007-328915

(51) Int. Cl. G06F 17/50

(52) U.S. Cl. 703/14

(57) ABSTRACT

Disclosed is a method in which a simulation is performed using a macro model for carrying out a simulation of a high-withstand-voltage MOSFET. The macro model is obtained by adding first and second JFETs to drain and source sides, respectively, of an NMOSFET; connecting one end of a first diode to a gate of the first JFET and connecting the other end of the first diode to the source of the NMOSFET; and connecting one end of a second diode to a gate of the second JFET and connecting the other end of the second diode to the drain of the MOSFET.

### REFERENCE TO RELATED APPLICATION

This application is based upon and claims the benefit of the priority of Japanese patent application No. 2007-328915, filed on Dec. 20, 2007, the disclosure of which is incorporated herein in its entirety by reference thereto.

### FIELD OF THE INVENTION

This invention relates to a MOS transistor simulation technique and, more particularly, to a method of circuit simulation of a high-withstand-voltage MOS transistor and an apparatus executing the method.

### DESCRIPTION OF RELATED ART

In the development of semiconductor devices, various simulations to verify whether the semiconductor device satisfies desired electrical characteristics are carrying out before the actual manufacturing of a semiconductor device. For example, SPICE is used as the circuit simulation. In order to assure simulation accuracy, it is required that characteristic values of the actual product and values calculated by SPICE be made to conform with regard to individual circuit elements in the semiconductor device.

BSIM3V3 model is generally used as a model of an ordinary MOS in SPICE. BSIM3V3 model is a model equation with which simulators now available on the market are necessarily equipped.

Owing to the recent trend toward SoC (Silicon on Chip) LSI, MOS transistors are wide spread used as peripheral transistors that require a high-withstand voltage. A high-withstand-voltage MOS transistor has a low-concentration impurity region disposed between a channel region and a drain (source) electrode.

However, the characteristic of this low-concentration impurity region is not expressed in the BSIM3V3 model. Thus, the characteristic will not conform.

Further, since a characteristic in which a drain current increases in proportion to a gate voltage constitutes the principle characteristic of the BSIM3V3 model, improvement is difficult.

In terms of the model equation, this problem is ascribable to the fact that an equation according to which a drain current changes little with respect to an increase in a gate voltage does not exist.

Further, it is ascribable to the fact that there is also no parameter representing self-heating in which a drain current decreases as a drain voltage increases.

FIG. 5 is a diagram illustrating a macro model for carrying out a simulation of a high-withstand-voltage MOS as disclosed in Patent Document 1. The element model of a high-withstand-voltage MOS is defined by combining a plurality of element models. The basic characteristic is expressed by a standard MOS model MMAIN, and a conductivity modulation effect of a low-concentration drain diffusion region is expressed by a variable element model JFET (Junction Field-Effect Transistor) in which the value of conductivity is changed by a drain voltage and a gate voltage.

Furthermore, a gate-to-drain overlap capacitance is expressed by a MOS capacitance MCAP between a gate and a bulk. A constant-resistance model RDI arranged in series with the capacitance model is added. This element model includes a diode model DDSUB between a drain electrode and a substrate, a diode model DDS between a drain electrode and a source electrode, an overlap capacitance model CGD between the gate electrode and the drain electrode and an overlap capacitance model GCS between the gate electrode and source electrode. This corresponds to the actual device characteristic.

[Patent Document 1]

Japanese Patent Kokai Publication No. JP-P2005-190328A

The matter disclosed in Patent Document 1 cited above is incorporated by reference in this application. An analysis of related art based upon the present invention is given below.

A circuit using a high-withstand-voltage MOS often is a circuit whose prime objective is bi-directional operation from the viewpoint of reliability and high-withstand voltage. For this reason, designs that employ a bidirectional MOS (a MOS on both sides or a MOS in both directions).

FIG. 6 is a diagram illustrating a VSD-ISD characteristic of a MOS. The VSD-ISD characteristic represents the characteristic of source-to-drain current ISD and source-to-drain voltage VSD, in a case where the source side has been placed at a high potential, with respect to a VDS-IDS characteristic (characteristic of drain-source current IDS and drain-source voltage VDS of an ordinary NMOS) in which the drain side of the NMOS has been placed at a high potential.

The characteristic diagram of FIG. 6 is a graph of the VSD-ISD characteristic, which is obtained by a comparing simulation values with measured values of an actual product under the condition VGD=0 to 40 V using the macro model for performing a simulation of a high-withstand-voltage MOS shown in FIG. 5. The characteristic in the case where the source of a MOS transistor is arranged in the high potential differs greatly between the simulation values and measured values of the actual product.

The reason for this is that in the macro model described as related art, the model has been created using a variable-element model JFET, which is an additional element, only a the drain side. This cannot be used as a bidirectional MOS the main objective of which is bidirectional operation.

### SUMMARY OF THE DISCLOSURE

The present invention seeks to solve one or more problems.

In the present invention, a simulation is performed using a macro model as a circuit simulation model of a MOS transistor, the macro model being obtained by inserting first and second transistor elements into power-supply paths on drain and source sides, respectively, of the MOS transistor and including circuit elements that turn on one of the first and second transistor elements and turn off the other in accordance with levels of potentials on the drain and source sides. In the present invention, the second transistor element turns on and the first transistor element turns off in a case where the drain side is at a high potential, and the first transistor element turns on and the second transistor element turns off in a case where the source side is at a high potential.

In one embodiment of the present invention, a simulation is performed using a macro model for carrying out a simulation of a high-withstand-voltage MOSFET, the macro model being obtained by adding first and second JFETs to drain and source sides, respectively, of the MOSFET, connecting one end of a first diode to a gate of the first JFET placed on the drain side of the MOSFET, connecting the other end of the first diode to the source of the MOSFET, connecting one end of a second diode to a gate of the second JFET placed on the source side of the MOSFET, and connecting the other end of the second diode to the drain of the MOSFET.

In one embodiment of the present invention, there is provided a macro model in which the MOSFET comprises an N-channel MOSFET; the first and second JFETs comprise first and second N-channel JFETs; the first and second N-channel JFETs are added to the drain and source sides, respectively, of the N-channel MOSFET; an anode of the first diode is connected to the gate of the first N-channel JFET placed on the drain side of the N-channel MOSFET; a cathode of the first diode is connected to the source of the N-channel MOSFET; an anode of the second diode is connected to the gate of the second N-channel JFET placed on the source side of the N-channel MOSFET; and a cathode of the second diode is connected to the drain of the N-channel MOSFET.

In one embodiment of the present invention, there is provided a macro model in which the MOSFET comprises a P-channel MOSFET; the first and second JFETs comprise first and second P-channel JFETs; the first and second P-channel JFETs are added to the drain and source sides, respectively, of the P-channel MOSFET; a cathode of the first diode is connected to the gate of the first P-channel JFET placed on the drain side of the P-channel MOSFET; an anode of the first diode is connected to the source of the P-channel MOSFET; a cathode of the second diode is connected to the gate of the second P-channel JFET placed on the source side of the P-channel MOSFET; and an anode of the second diode is connected to the drain of the P-channel MOSFET.

In one embodiment of the present invention, a simulation is performed using a macro model for carrying out a simulation of a high-withstand-voltage MOSFET, the macro model being obtained by adding second and third MOSFETs to drain and source sides, respectively, of a first MOSFET; connecting one end of a first diode to a gate of the second MOSFET placed on the drain side of the first MOSFET; connecting the other end of the first diode to a source of the first MOSFET; connecting one end of the second diode to a gate of the third MOSFET placed on the source side of the first MOSFET; and connecting the other end of the second diode to the drain of the first MOSFET.

In one embodiment of the present invention, there is provided a macro module in which the first MOSFET comprises an N-channel MOSFET and the second and third MOSFETs comprise second and third N-channel MOSFETs; the second and third N-channel MOSFETs are added to the drain and source sides, respectively, of the first N-channel MOSFET; an anode of the first diode is connected to the gate of the second N-channel MOSFET placed on the drain side of the first N-channel MOSFET; a cathode of the first diode is connected to the source of the first N-channel MOSFET; an anode of the first diode is connected to the gate of the third N-channel MOSFET placed on the source side of the first N-channel MOSFET; and a cathode of the second diode is connected to the drain of the first N-channel MOSFET.

In one embodiment of the present invention, there is provided a macro module in which the first MOSFET comprises a P-channel MOSFET and the second and third MOSFETs comprise second and third P-channel MOSFETs; a cathode of the first diode is connected to the gate of the second P-channel MOSFET placed on the drain side of the P-channel MOSFET; an anode of the first diode is connected to the source of the first P-channel MOSFET; a cathode of the second diode is connected to the gate of the third P-channel MOSFET placed on the source side of the first P-channel MOSFET; and an anode of the second diode is connected to the drain of the first P-channel MOSFET.

In a circuit simulation model of a high-withstand-voltage MOS transistor in accordance with the present invention, element models are placed on the drain and source sides of a standard element model, it is possible to implement a model as a bidirectional MOS and the simulation accuracy of a high-withstand-voltage MOS transistor can be improved.

Still other features and advantages of the present invention will become readily apparent to those skilled in this art from the following detailed description in conjunction with the accompanying drawings wherein only the preferred embodiments of the invention are shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTIONS OF THE DRAWINGS

FIG. 1 is a diagram illustrating a macro model of a first exemplary embodiment according to the present invention;

FIG. 2 is a VSD-ISD characteristic diagram according to the first exemplary embodiment;

FIG. 3 is a diagram illustrating a macro model of a second exemplary embodiment according to the present invention;

FIG. 4 is a diagram illustrating a macro model of a third exemplary embodiment according to the present invention;

FIG. 5 is a diagram illustrating a macro model according to the related art; and

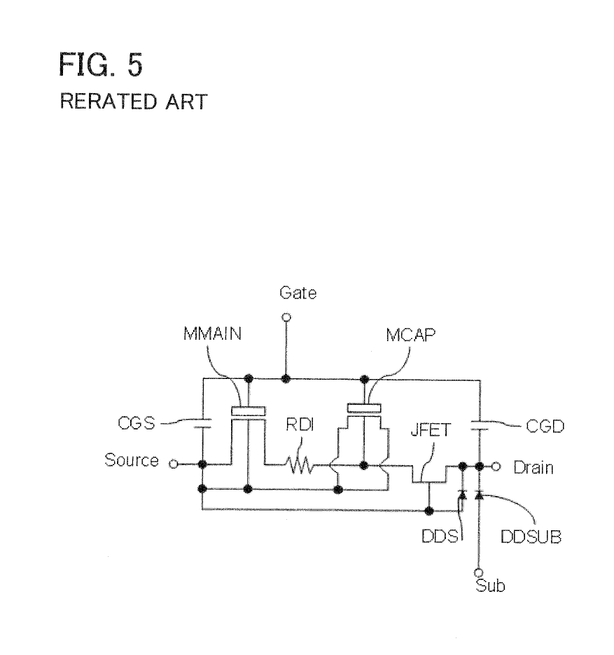

FIG. 6 is a VSD-ISD characteristic diagram according to the related art.

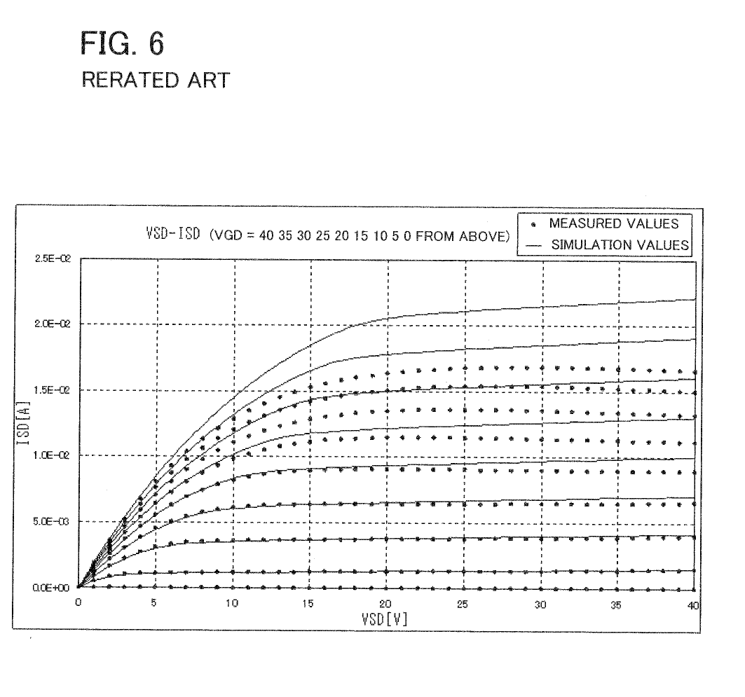

### PREFERRED MODES OF THE INVENTION

In the present invention, a model of a bidirectional MOS is realized in a circuit simulation model of a high-withstand-voltage MOS by arranging parasitic elements for a high-withstand voltage macro on drain and source sides, respectively, and adding diodes to the parasitic elements for the high-withstand-voltage macro, respectively, such that if one of the parasitic elements is being used, the other parasitic element is placed in a short-circuited state.

In the present invention, there is provided a simulation method (or simulation apparatus, a program for executing the simulation by a computer, or a storage medium on which the program has been recorded) of performing a simulation using a macro model for carrying out a simulation of a high-withstand-voltage MOSFET, the macro model being obtained by adding first and second JFETs to drain and source sides, respectively, of the MOSFET, connecting one end of a first diode to a gate of the first JFET placed on the drain side of the MOSFET, connecting the other end of the first diode to the source of the MOSFET, connecting one end of a second diode to a gate of the second JFET placed on the source side of the MOSFET, and connecting the other end of the second diode to the drain of the MOSFET.

In exemplary embodiments in accordance with the present invention, there is provided a simulation method, a simulation apparatus, a program for executing the simulation by a computer, or a storage medium on which the program has been recorded of performing a simulation using a macro model for carrying out a simulation of a high-withstand-voltage MOSFET, the macro model being obtained by adding first and second JFETs of the same conductivity type to drain and source sides, respectively, of the MOSFET, connecting one end of a first diode to a gate of the first JFET placed on the drain side of the MOSFET, connecting the other end of the first diode to the source of the MOSFET, connecting one end of a second diode to a gate of the second JFET placed on the source side of the MOSFET, and connecting the other end of the second diode to the drain of the MOSFET.

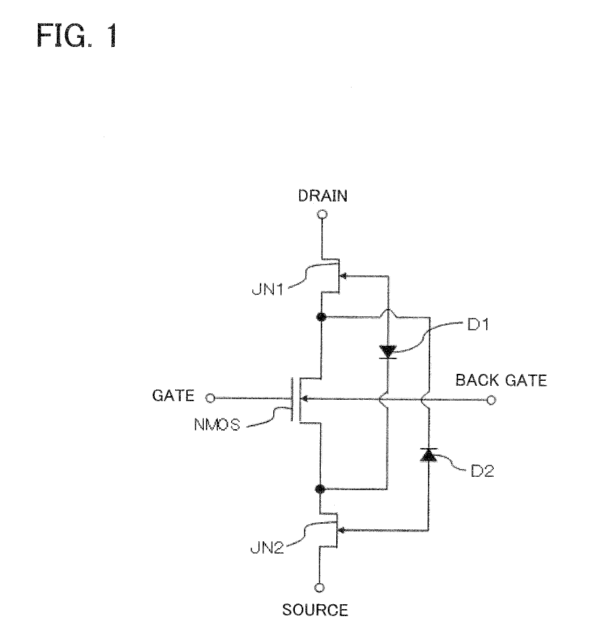

FIG. 1 is a diagram illustrating the configuration of a macro model for performing a simulation of a high-withstand-voltage MOS according to an exemplary embodiment of the present invention. It should be noted that the macro model shown in FIG. 1 is stored on a storage medium that serves as a library of the circuit simulation. As illustrated in FIG. 1, an N-channel JFET (JN1) is added to the drain side of an N-channel MOSFET (referred to as an “NMOS” below) representing a basic characteristic, and an N-channel JFET (JN2) is added to the source side of the NMOS. An anode of a diode (D1) is connected to a gate of the N-channel JFET (JN1), and a cathode of the diode (D1) is connected to the source of the NMOS. An anode of a diode (D2) is connected to a gate of the N-channel JFET (JN2), and a cathode of the diode (D2) is connected to the drain of the NMOS.

By thus connecting the N-channel JFETs (JN1, JN2) to the drain and source sides, respectively, of the NMOS and connecting the diodes (D1, D2) to the gates of the N-channel JFETs (JN1, Jn2), respectively, it is so arranged that only one of the N-channel JFETs (JN1, JN2) will operate. Specifically, when the potential on the drain side of the NMOS is high and the potential on the source side the NMOS is near zero, the diode (D1) turns on, the diode (D2) turns off, the N-channel JFET (JN1) is in an OFF state, in which it is difficult for current to flow, and the N-channel JFET (JN2) is in an ON state. That is, a state in which only the N-channel JFET (JN2) operates is attained.

Conversely, in a case where the potential on the drain side of the NMOS is near zero and the potential on the source side of the NMOS is high, the diode (D2) turns on, the diode (D1) turns off, the N-channel JFET (JN2) is in an OFF state, in which it is difficult for current to flow, and the N-channel JFET (JN1) turns on. That is, a state in which only the N-channel JFET (JN1) operates is attained.

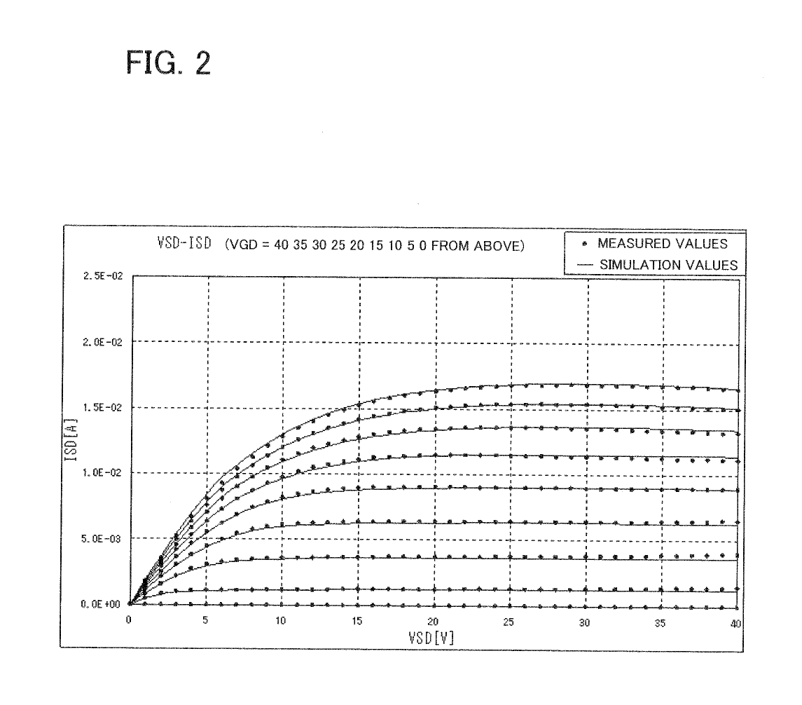

FIG. 2 is a graph of the VSD-ISD characteristic, which is obtained by comparing result of simulation and measured values of an actual product under the condition VGD=0 to 40 V using the macro model according to the present invention. That is, FIG. 2 is a diagram illustrating a specific example of result of a simulation based upon the simulation method of the present invention. In FIG. 2, source-to-drain voltage VSD [V] and source-to-drain current ISD [A] are plotted along the vertical and horizontal axes, respectively, the measured values of the actual product are indicated by the dots, and the simulation values are indicated by the solid lines.

In a case where the source side of the NMOS is made a high potential, the simulation values and measured values of the actual product substantially coincide. The reason for this is as follows: In a case where the potential on the drain side of the NMOS is high, the N-channel JFET (JN2) operates. In a case where the potential on the source side of the NMOS is high, the N-channel JFET (JN1) operates. As a result, even in a case where either the drain side or source side is high, it is possible to realize the characteristic of a low-concentration impurity region that exists between the channel region and drain (source) electrode of a high-withstand-voltage MOS transistor.

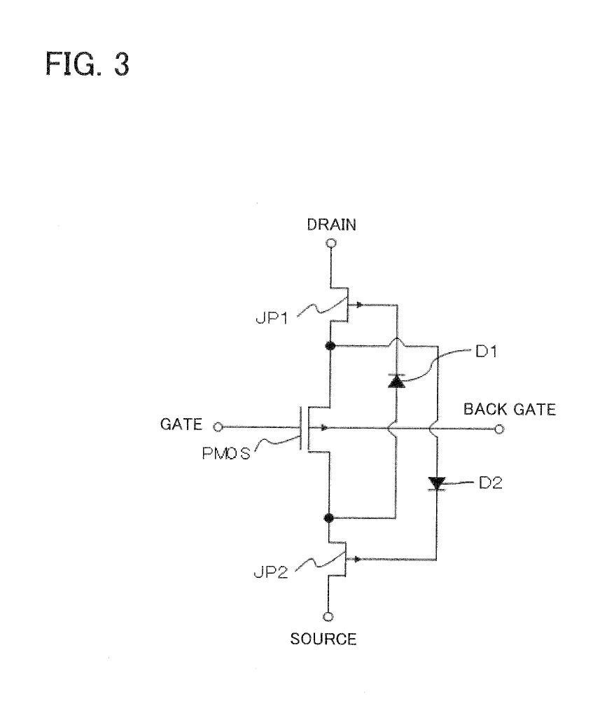

FIG. 3 is a diagram illustrating the configuration of a macro model according to a second exemplary embodiment of the present invention. Whereas the first exemplary embodiment is a high-withstand-voltage NMOS, in this exemplary embodiment the macro model is a high-withstand-voltage P-channel MOSFET (referred to as a “PMOS” below).

In the configuration of the macro model, a PMOS replaces the NMOS of FIG. 1, P-channel JFETs (JP1, JP2) replace the N-channel JFETs (JP1, JP2) and diodes (D1, D2) whose polarities are reversed from those in FIG. 1 are disposed by reversing the directions of the diodes (D1, D2) in FIG. 1. That is, the P-channel JFETs (JP1, JP2) are added to the drain and source sides of the PMOS, the cathode of the diode (D1) is connected to the gate of the P-channel JFET (JP1), the anode of the diode (D1) is connected to the source of the PMOS, the cathode of the diode (D2) is connected to the gate of the P-channel JFET (JP2), and the anode of the diode (D2) is connected to the drain of the PMOS.

When the potential on the source side of the PMOS is high and the potential on the drain side of the PMOS is near zero, the diode (D1) turns on, the diode (D2) turns off, the P-channel JFET (JP1) attains the OFF state, in which it is difficult for current to flow, and the P-channel JFET (JP2) turns on. That is, a state in which only the P-channel JFET (JP2) operates is attained.

Conversely, in a case where the potential on the source side of the PMOS is near zero and the potential on the drain side of the PMOS is high, the diode (D2) turns on, the diode (D1) turns off, the P-channel JFET (JP2) attains the OFF state, in which it is difficult for current to flow, and the P-channel JFET (JP1) turns on. That is, a state in which only the P-channel JFET (JP1) operates is attained.

By virtue of the configuration shown in FIG. 3, a simulation model of a high-withstand-voltage PMOS can be realized. This makes possible a highly accurate simulation of a high-withstand-voltage PMOS.

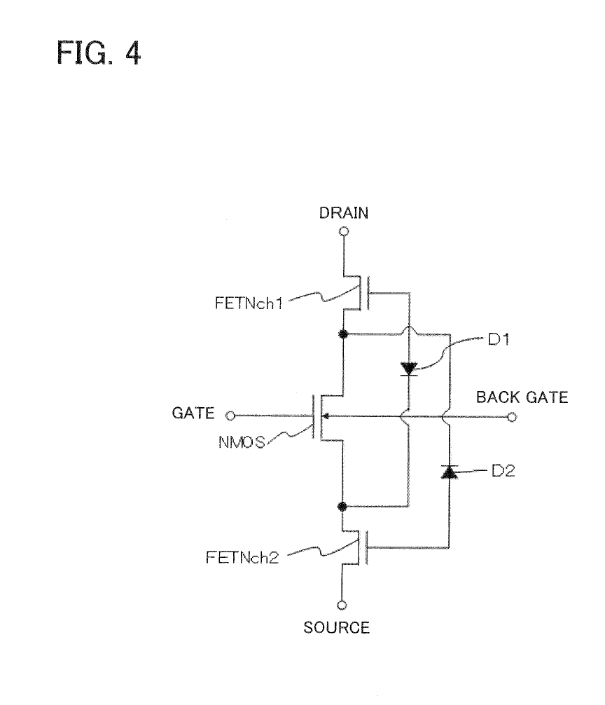

FIG. 4 is a diagram illustrating a macro model according to a third exemplary embodiment of the present invention. In the first exemplary embodiment, N-channel JFETs are utilized in the configuration of the macro model. In this exemplary embodiment, however, only MOSFETs are used.

A FETNch1 and a FETNch2, each of which is an NMOS, replace JN1 and JN2, which are N-channel JFETs, in FIG. 1.

By virtue of this configuration, the MOS circuit model generally has more setting parameters for performing various simulation settings as compared with the JFET circuit model. In this exemplary embodiment, the configuration is implemented using this circuit model of a MOS and more diverse settings are made. This makes possible a simulation based upon a complicated macro model.

In accordance with this exemplary embodiment, the simulation of a high-withstand-voltage MOS can be performed more accurately by placing element models on the drain and source sides of a standard element model.

Though the present invention has been described in accordance with the foregoing exemplary embodiments, the invention is not limited to these exemplary embodiments and it goes without saying that the invention covers various modifications and changes that would be obvious to those skilled in the art within the scope of the claims.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A simulation method comprising:
performing a simulation using a macro model as a circuit simulation model of a MOS transistor,
the macro model being obtained by:
inserting first and second transistor elements into power-supply paths on drain and source sides, respectively, of the MOS transistor; and
arranging circuit elements that turn on one of the first and second transistor elements and turn off the other in accordance with levels of potentials on the drain and source of the MOS transistor.

2. The method according to claim 1, comprising:
the circuit elements turning on the second transistor element and turning off the first transistor element, when the drain of the MOS transistor is at a high potential; and
the circuit elements turning on the first transistor element and turning off the second transistor element, when the source of the MOS transistor is at a high potential.

3. A simulation method comprising:
performing a simulation using a macro model for carrying out a simulation of a high-withstand-voltage MOSFET, the macro model being obtained by:
adding first and second JFETs to drain and source sides, respectively, of the MOSFET;
connecting one end of a first diode to a gate of the first JFET placed on the drain side of the MOSFET and connecting the other end of the first diode to the source of the MOSFET; and
connecting one end of a second diode to a gate of the second JFET placed on the source side of the MOSFET, and connecting the other end of the second diode to the drain of the MOSFET.

4. The method according to claim 3, wherein the simulation is performed using a macro model in which the MOSFET comprises an N-channel MOSFET and the first and second JFETs comprise first and second N-channel JFETs, respectively;
the first and second N-channel JFETs are added to the drain and source sides, respectively, of the N-channel MOSFET;
an anode of the first diode is connected to the gate of the first N-channel JFET placed on the drain side of the N-channel MOSFET, and a cathode of the first diode is connected to the source of the N-channel MOSFET; and
an anode of the second diode is connected to the gate of the second N-channel JFET placed on the source side of the N-channel MOSFET, and a cathode of the second diode is connected to the drain of the N-channel MOSFET.

5. The method according to claim 3, wherein the simulation is performed using a macro model in which the MOSFET comprises a P-channel MOSFET and the first and second JFETs comprise first and second P-channel JFETs, respectively;
the first and second P-channel JFETs are added to the drain and source sides, respectively, of the P-channel MOSFET;
a cathode of the first diode is connected to the gate of the first P-channel JFET placed on the drain side of the P-channel MOSFET, and an anode of the first diode is connected to the source of the P-channel MOSFET; and
a cathode of the second diode is connected to the gate of the second P-channel JFET placed on the source side of the P-channel MOSFET, and an anode of the second diode is connected to the drain of the P-channel MOSFET.

6. A simulation method comprising:
performing a simulation using a macro model for carrying out a simulation of a high-withstand-voltage MOSFET,
the macro model being obtained by:
adding second and third MOSFETs to drain and source sides, respectively, of a first MOSFET;
connecting one end of a first diode to a gate of the second MOSFET placed on the drain side of the first MOSFET, and connecting the other end of the first diode to a source of the first MOSFET; and
connecting one end of a second diode to a gate of the third MOSFET placed on the source side of the first MOSFET, and connecting the other end of the second diode to the drain of the first MOSFET.

7. The method according to claim 6, wherein the simulation is performed using a macro model in which the first MOSFET comprises an N-channel MOSFET and the second and third MOSFETs comprise second and third N-channel MOSFETs, respectively,
the second and third N-channel MOSFETs are added to the drain and source sides, respectively, of the first N-channel MOSFET;
an anode of the first diode is connected to the gate of the second N-channel MOSFET placed on the drain side of the first N-channel MOSFET, and a cathode of the first diode is connected to the source of the first N-channel MOSFET; and
an anode of the first diode is connected to the gate of the third N-channel MOSFET placed on the source side of the first N-channel MOSFET, and a cathode of the second diode is connected to the drain of the first N-channel MOSFET.

8. The method according to claim 6, wherein the simulation is performed using a macro model in which the first MOSFET comprises a P-channel MOSFET and the second and third MOSFETs comprise second and third P-channel MOSFETs, respectively,
a cathode of the first diode is connected to the gate of the second P-channel MOSFET placed on the drain side of the P-channel MOSFET, and an anode of the first diode is connected to the source of the first P-channel MOSFET; and
a cathode of the second diode is connected to the gate of the third P-channel MOSFET placed on the source side of the first P-channel MOSFET, and an anode of the second diode is connected to the drain of the first P-channel MOSFET.

9. A recording medium on which is stored the macro model used by the simulation method according to claim 1.

10. A simulation apparatus executing the simulation method according to claim 1.
